(19) United States
(12) Patent Application Publication
(10) Pub. No.: US 2010/0199308 A1
(43) Pub. Date: Aug. 5, 2010

(54) Channel Change Insert

(76) Inventors: Neale Hall, Keighley (GB); Keith Gerhards, Parker, CO (US); A. Terry Pattison, Castle Rock, CO (US)

Correspondence Address: DORSEY & WHITNEY LLP;on behalf of EchoStar Technologies, L.L.C., 370 Seventeenth St., Suite 4700, Denver, CO, 80202-5647, US

(21) Appl. No.: 12/363,228

(22) Filed: Jan. 30, 2009

(51) Int. Cl. G06F 3/00

(52) U.S. Cl. 725/40; 725/38

(57) ABSTRACT

Embodiments disclosed herein are directed to displaying supplemental content during a time period that occurs when a receiver switches from a first broadcast channel to a second broadcast channel. The supplemental content may include still or motion graphics, logos, animation, advertisements and/or modified frames of one or more of the first and second display channels. In connection with displaying supplemental content during a channel change, a receiver may use electronic program guide information to obtain graphics or scheduling information.

### BACKGROUND

1. Technical Field

Implementations discussed herein are generally directed to displaying supplemental content during a channel change, and more particularly to displaying graphics or other content on a display device during a time period during which the display device switches from displaying a first channel to displaying a second channel.

2. Background Discussion

Switching between channels by a television receiver typically includes an interim period during which the receiver switches between a first channel and a second channel. In particular, switching between a first channel and a second channel typically includes switching a tuner component from a setting that receives the first channel to a setting that receives the second channel. A decoder component is typically connected to the tuner and is configured to convert the signal received by the tuner into a format that is displayable on a display device such a television screen. Typically, during the interim period a channel setup process occurs for the second channel. In particular, the decoder must receive a certain amount of the tuned signal prior to being able to produce a signal that can be coherently displayed. While the second channel is set-up, it may be the case that no coherent video content is available to display for a certain time period. During this time, receivers typically display a blank or a black screen. Alternatively, incoherent video content may be displayed giving a jumbled or fragmented appearance as the second channel is set up. Accordingly, during the interim period of a channel change, a viewer may see only jumbled video or nothing at all for a time during a channel change, thereby creating a sub-optimal viewing experience.

### SUMMARY

Implementations discussed herein are directed to displaying supplemental content during a time period that occurs when a receiver switches from a first broadcast channel to a second broadcast channel. The supplemental content may include still or motion graphics, logos, animation, advertisements and/or modified frames of one or more of the first and second display channels. The supplemental content may be associated with display inserts stored or transmitted to the receiver. The display inserts may permanently reside on the receiver or may reside on the receiver only for a fixed time period. The display inserts may be received from a service provider. In connection with displaying supplemental content during a channel change, a receiver may use electronic program guide information to obtain graphics or scheduling information.

Embodiments are directed to a method of displaying supplemental content, including: receiving a command to change a display from a first channel to a second channel; initiating a channel change from the first channel to the second channel; displaying supplemental content during a setup period for the second channel; and displaying the second channel after the setup period.

Embodiments are directed to a system for displaying content, including: a receiver having a processor, the receiver operable to receive content on a plurality of channels; a storage device connected to the processor, the storage device including one or more display inserts; and a display mechanism connected to the receiver, the display mechanism operable to display content received by the receiver on the plurality of channels; wherein during a channel change from a first channel to a second channel, the processor displays supplemental content on the display mechanism, the supplemental content being specified by the display insert.

Embodiments are directed to a method of providing supplemental content, including: receiving supplemental content; attaching use-specifier information to the supplemental content; and transmitting the supplemental content to a receiver; wherein the use-specifier information indicates that the supplemental content is to be displayed during a channel change from a first channel to a second channel.

### BRIEF DESCRIPTION OF THE DRAWINGS

FIG. 1 is a schematic illustration of an operating environment showing components and features of implementations discussed herein;

FIG. 2 is a schematic illustration of an operating environment showing components and features of implementations discussed herein that operate in the context of a satellite broadcast system;

FIG. 3 is a flowchart illustrating operations in a method in accordance with implementations discussed herein; and

FIG. 4 is another flowchart illustrating operations in a method in accordance with implementations discussed herein.

### DETAILED DESCRIPTION OF EMBODIMENTS

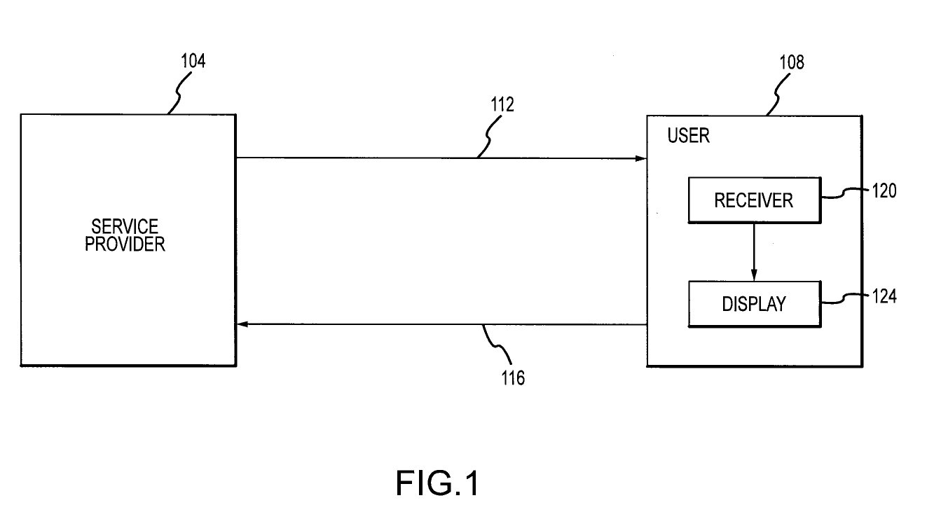

FIG. 1 is a schematic illustration of a general operating environment showing components and features of embodiments and implementation discussed herein. FIG. 1 includes a service provider 104 that provides product service for a user 108. The service provider 104 transmits a signal along a first communication path 112 to the user 108. The user 108 may also request information or changes to his or her account over a second communication path 116 (or in some cases, the first communication path 112) provided between the user 108 and the service provider 104. A product service may include, for example, a transmission to a television receiver 120 that is associated with the user 108. In turn, the receiver 120 may display transmitted content on a display 124.

As used herein, a service provider 104 may include any entity providing broadcast service such as, without limitation, a satellite broadcast, a direct television broadcast or a cable television broadcast. The receiver 120 may be associated with an individual, location and/or a business that receives a broadcast from the service provider 104, and can include a set-top box (STB), Digital Video Recorder (DVR), a cable receiver, a general purpose computer and so on. A receiver 120 may also include a cable modem or raster that receives streaming video. The broadcast may be received through a subscription to the service. It should be understood that the term “broadcast” generally embraces not only satellite or terrestrial broadcasts, but also transmission of information across any wired or wireless transmission medium. Accordingly, a “broadcast” encompasses transmission of information across a cable network (for example a cable headend to cable receiver), an Internet or other computer-accessible medium (including a local area network, wide-area network, and so on), including Internet protocol television transmissions, a wireless network such as a radio frequency or infrared network, and so on.

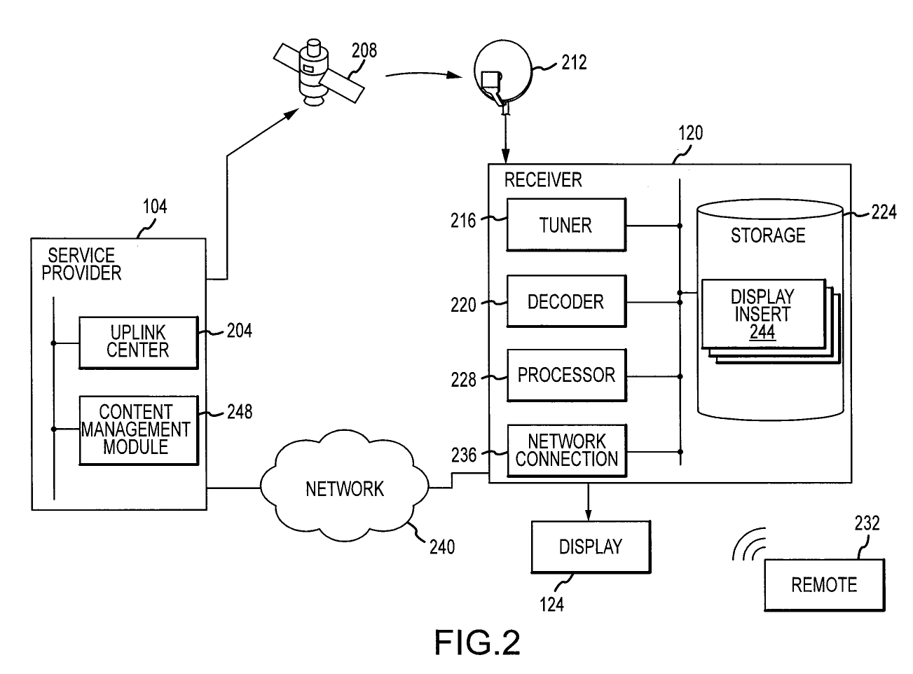

FIG. 2 is a schematic illustration of an operating environment showing components and features of embodiments discussed herein that operate in the context of a satellite broadcast service, as a further refinement of the general operating environment of FIG. 1. As shown in FIG. 2, a service provider 104 may include an uplink center 204. The uplink center 204 may include a transmitter or other equipment operable to transmit a modulated signal having data representing audio and/or visual content. The modulated signal is received at satellite 208, which in turn rebroadcasts the modulated signal to be received at one or more of terrestrial locations. The rebroadcast signal is received from the satellite 208 at one or more satellite dishes 212, each of which are typically associated with a particular receiver 120. Again, it should be noted that embodiments may operate with different broadcast services. Accordingly, although a satellite system is provided as an example of a broadcast system, it should be understood that other networks or broadcasts for transmitting data may be used by alternative embodiments. For example, embodiments may be implemented in connection with a cable service. In this case, the service provider 104 and the receiver 120 may communicate over a communication path that includes various combinations of local and wide area networks and/or the Internet.

The receiver 120 may include a tuner 216 operable to receive the broadcast signal through the satellite dish 212. The receiver 120 may also include a decoder 220 to decode the received broadcast signal. The decoder 220 may be programmed to decrypt or otherwise decode some or all of the satellite broadcast in accordance with purchases and selections made by a user. The receiver 120 may additionally include a processor 228 operable to run executable code in connection with various functions associated with the receiver 120. For example, the processor 228 may display graphics, images, animations or other content on the display 124. Among other functions, the processor 228 may also receive, store and/or display an Electronic Program Guide (EPG), which may provide a schedule of program content and/or other features.

The processor 228 may also perform tasks such as executing commands received from a user 108. User commands may be sent to the receiver 120 through a remote 232 or other wireless device, although it should be appreciated that other input devices such as a computer mouse or touch screen may be used. Such commands sent to the receiver 120 may include, for example, a command to change the displayed channel or a command to request changes to the broadcast service. Commands sent to the receiver 120 may be entered through a dedicated display menu.

In the case of receiving commands or other information relating to changes to the account status, the processor 228 may be further operable to initiate or facilitate transmission of one or more messages to the service provider 104. In this regard, the receiver 120 may additionally include a network connection 236 that provides a connection to network 240. Through the network connection 236 and across the network 240, the receiver 120 may communicate with the service provider 104. In accordance with certain embodiments, the receiver 120 and the service provider 104 communicate over standard telephone lines. Here, the network 240 may include the public switched telephony network (PSTN). However, it should be appreciated that the network 240 may include any type of network capable of data communication, such as for example, a local or wide area network or the Internet.

A memory or other storage device 224, such as magnetic, flash or optical storage, may additionally be provided to store data received from the decoded satellite signal. The storage device 224 may be located within the receiver 120, or separately from the receiver 120. The stored data set may include audio and/or visual content to be transmitted and displayed through display 124. The storage device 224 may include one or more display inserts 244. Generally, a display insert 244 takes the form of content that may be shown on the display 124 by the receiver while the receiver 120 switches between channels. A display insert 244 may include an application, file, or other data that is useable by the processor 228 to display content on the display 124. As used herein, an application includes processor executable code that may be run to carry out one or more functions associated with the receiver 120. “Processor executable code” includes any computer-readable media or commands that may be ultimately interpreted by a processor, such as HTML or XML files that are rendered into user-viewable applications by an application executed by the processor. Generally, the display insert 244 may include audio/visual content such as still images, video images, animation and/or audio. Portable Network Graphics (PNG) or other appropriate formats, such as for example, Tagged Image File Format (TIFF), Joint Photographic Experts Group (JPEG), Motion Picture Experts Group (MPEG)-2, MPEG-4 may be used to display an image or video. The audio/video content may be provided to the display 124 for display during an interim period between display of two broadcast channels. In displaying graphics, whether still or motion graphics, the implementations discussed herein may utilize the normal and/or advanced graphic features associated with the processor 228.

The processor 228 may display one or more display inserts as content on the display 124 at a predetermined time. For example, supplemental content may be displayed by the processor 228 on the display 124 during a channel change. As used herein, “supplement content” refers to any displayed content that is added to the display during a channel change. Typically, the supplement content does not include status bars or indicators that simply indicate that a channel change is in progress. Typically, when the tuner 216 changes between broadcast channels an interim period occurs. During this interim period, the tuner 216 and decoder 220 switch from tuning and decoding the first channel to tuning and decoding a second channel. This typically includes an initial setup period that occurs while the second channel is initially decoded for display. In accordance with implementations discussed herein, a receiver 120 may display supplemental content on the display 124 during this initial setup period. More particularly, during the initial setup period the receiver 120 may run or otherwise display supplemental content that is associated with a particular display insert 244.

A display insert 244 may include a logo or other graphic. The logo or graphic may be one that is associated with a particular network. In this regard, the receiver 120 may display the network logo on the display 124 as supplemental content during the interim period that occurs when the receiver 120 switches from a first channel to a second channel. The network logo may be one associated with the first channel and/or the second channel. For example, if a user changes the broadcast channel from NBC to CBS, the receiver 120 may display an NBC and/or a CBS logo during the channel change. Alternatively or in combination, the receiver 120 may display a logo associated with a broadcast service provider during the channel change period.

A display insert 244 may include an application or processor executable code that is operable to capture a frame or other portion of a broadcast and to display a modified or otherwise manipulated version of the captured frame. Such modified or manipulated images may be displayed on the display 124 as supplemental content during a change from a first channel to a second channel. For example, when the broadcast channel is changed, the receiver 120 may display an image that is folded, warped or compressed into a point on the display 124. The image may include a rendering of one or more frames of the first channel as a planar object. Once the frame from the first channel is folded into the point, the receiver 120 may display an unfolding of a second planar object from the point on the display 124. This unfolded object or frame may include an image constructed from the second broadcast channel. Once the second frame or object has completely unfolded from the point on the display 124, a real-time or continuous display of the second broadcast channel may occur on the display 124.

A display insert 244 may include processor executable code operable to implement a gradual fade out of the first broadcast channel and a gradual fade in of the second broadcast channel. More particularly, during the interim period between a channel change from a first channel to a second channel, the receiver 120 may display on the display 124 a gradual fade out of the first channel to a blank or black screen. Following this, the receiver 120 may display from the blank or black screen a gradual fade in of the second broadcast channel. In one embodiment, the display 124 fades directly from the first channel to the second channel. In another embodiment the display “wipes” from the first channel to the second channel.

A display insert 244 may include an animation or other motion graphic. In particular, the display insert 244 may include a processor executable code usable by the processor 228 to display a motion graphic on the display 124 as supplement content during a channel change. For example, the motion graphic may be any desired animation that fills a small amount of time between the display of the first channel and the display of the second channel. For example, the motion graphic might include a graphic of a bumblebee or other character that gradually or otherwise moves randomly across the screen. The motion graphic may be any type of animation or other motion graphic that is desired to fill the time interval between channel changes.

A display insert 244 may include an advertisement. The advertisement may be displayed by the processor 228 on the display 124 as supplemental content during a channel change. The advertisement may include a product logo or company logo associated with the product or service that is being advertised. Alternatively or in combination, the advertisement may include a brief motion graphic or other animation that depicts the product or service that is advertised. A display insert 224 may refer to a downloaded video or recorded broadcast that is stored locally at the receiver 120. In particular, the display insert 224 may list titles of stored content or may display a logo or graphic associated with stored content. The display insert may also display a name, logo, graphic or other information associated with an actor or studio associated with stored or displayed content.

In accordance with implementations discussed herein, the display inserts 244 may be periodically transmitted to and received by the receiver 120. For example, the service provider 104 may deliver a particular display insert 244 as part of a satellite broadcast. Here, the display insert 244 may be delivered during the Vertical Blanking Interval (VBI) period of the satellite broadcast. Alternatively, the display insert 244 may be delivered to the receiver 120 during periods of time in which the receiver 120 is idle or otherwise not in use for displaying broadcast content on the display 124. The service provider 104 may also provide a display insert 244 through the network 240. Here, the display insert 244 may be received through the network connection 236 and may include digital files delivered by way of an appropriate network protocol. In delivering a particular display insert 244, the service provider 104 may specify a time period in which the display insert 244 is to remain in storage 224. In particular, the display insert 244 may be associated with an expiration date, after which the display insert 244 is no longer usable. An expiration date may be used in connection with advertisements or advertising campaigns that only last for a particular amount of time.

A particular display insert 244 may permanently reside on the storage 224. For example, a particular display insert 244 may include a network graphic or other logo that is stored for an indefinite amount of time in the storage 224. In connection with network logos or other graphics, the receiver 120 may receive a digital file including the graphic or logo from a service provider 104. Alternatively or in combination, the receiver 120 may acquire the graphic or logo from the data associated with the electronic program guide (EPG), which normally includes such graphics or images.

In displaying supplemental content, the processor 228 may also reference or access scheduling information associated with the EPG. In particular, the processor 228 may access the EPG to determine what program or what type of program is being displayed or is scheduled to be displayed on either a current channel or a channel to which a user has switched. Based on the information so obtained, the processor 228 may select a particular type of supplemental content to display. In displaying supplemental content, the receiver 120 may utilize a dedicated graphical user interface or graphics subsystem. The processor 228 may also include enhanced graphics capabilities usable to display supplemental content of the display 124.

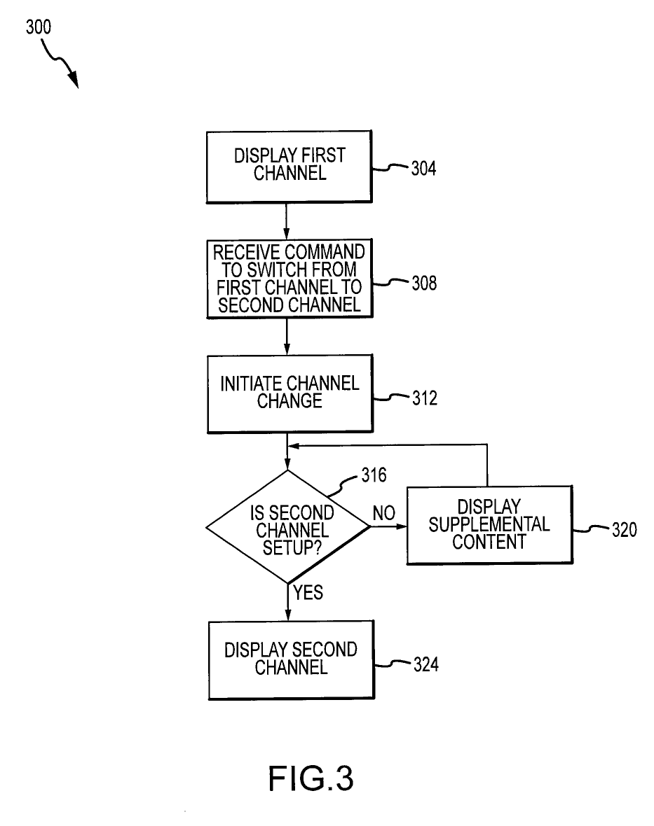

Turning now to FIG. 3, reference is made to the flowchart 300. The flowchart 300 generally illustrates a method in accordance with implementations discussed herein. With specific reference to the receiver 120, the method 300 begins initially at operation 304. At operation 304, the receiver 120 displays a first broadcast channel on the display 124. After operation 304, operation 308 may be executed.

At operation 308, the receiver 120 receives a command to change the broadcast channel from the first broadcast channel to a second broadcast channel. This may occur, for example, as the result of a user input received from the remote 232 or other wireless device. The channel may also change as the result of automatic timer that changes the channel to record a designated program. After operation 308, operation 312 may be executed.

At operation 312, the requested or programmed channel change is initiated at the receiver 120. In particular, the tuner 216 is switched from the first broadcast channel to the second broadcast channel. During the channel change, coherent video content may not be available for display on the display 124. In this regard, operation 316 may be executed following the initiation of the channel change at operation 312.

At operation 316, a determination is made by the receiver 120 as to whether the second channel has been set up. More particularly, a determination is made by the receiver 120 (and typically by the processor 228) as to whether the second display channel is sufficiently decoded by the decoder 220 to display coherent video content on the display 124. If a determination is made by the receiver 120 that the second channel has not yet set up, operation 320 may be executed.

At operation 320, the processor 228 may display supplemental content on the display 124. The supplemental content may be specified or otherwise associated with a display insert 244, which may be stored in the storage 224. The supplemental content may include, for example, a graphic, a logo, audio, a motion graphic or other animation, a fade in and fade out of the first and second broadcast channel. As described above, the supplemental content may include a rendering of a portion the first channel as planar object that is folded into a point and a rendering of a portion of the second channel content as a planar object that is unfolded from a point. Following the display of supplemental content at operation 320, operation 316 may again be executed.

If, at operation 316, it is determined by the receiver 120 that the second display channel has set up, operation 324 may be executed. More particularly, a determination is made that the decoder 220 has sufficiently decoded the incoming broadcast signal in order to display a coherent video on the display 124. Accordingly, at operation 324, the second broadcast channel is displayed on the display 124.

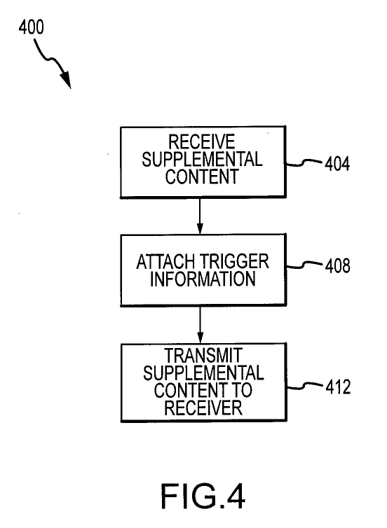

Turning now to FIG. 4 reference is made to a flowchart 400. The flowchart 400 generally illustrates a method in accordance with implementations discussed herein. The flowchart 400 illustrates a method of providing display inserts 244 to a receiver 120. With specific reference to the service provider 104 shown in FIG. 2, the method 400 begins initially at operation 404. At operation 404, the service provider 104, through the operation of a content management module 248, may receive supplemental content to be associated with a channel change or otherwise displayed at a receiver 120 during the time period that occurs during a switch from a first channel to a second channel. Supplemental content may be received from and compiled into display inserts 244 by the content management module 248. The supplemental content may be received from such sources as advertising providers, programmers and/or other third parties. The supplemental content may also be received from sources internal to the service provider 104. Following operation 404, operation 408 may be executed.

At operation 408, the content management module 248 may associate timer and/or trigger information with a particular display insert 244. For example, the associated information may specify a particular manner in which the display insert 244 is to be used by the receiver 120. In particular, the associated information may specify that a display insert 244 may be associated with a change to or from a particular channel and/or particular broadcast program. The attached information may also specify that a display insert 244 may be usable only for a predetermined amount of time. Following operation 408, operation 412 may be executed.

At operation 412, one or more display inserts 244 may be transmitted from the service provider 104 to the receiver 120. This may occur over any appropriate transmission means including satellite broadcast and/or other network transaction. The display inserts 244 may be transmitted to the receiver 120 as part of metadata that is transmitted to the receiver 120. In one embodiment, display inserts 244 may be sent in unused portions of a transponder signal.

The foregoing merely illustrates certain principles of embodiments. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the embodiments and are thus within the spirit and scope of the present invention. From the above description and drawings, it will be understood by those of ordinary skill in the art that the particular embodiments shown and described are for purposes of illustration only and are not intended to limit the scope of the present invention. References to details of particular embodiments are not intended to limit the scope of the invention

What is claimed is:

1. A method of displaying supplemental content, comprising:
receiving a command to change a display from a first channel to a second channel;
initiating a channel change from the first channel to the second channel;
displaying supplemental content during a setup period for the second channel; and
displaying the second channel after the setup period.

2. The method of claim 1, wherein the supplemental content includes a graphical logo associated with a service provider.

3. The method of claim 1, wherein the supplemental content includes a graphical logo associated with at least one of the first channel and the second channel.

4. The method of claim 1, further compromising:
searching an electronic program guide to determine a content of at least one of the first and second channels; and
selecting the supplemental content based on the content of at least one of the first and second channels.

5. The method of claim 1, wherein the supplemental content includes graphical image taken from an electronic program guide.

6. The method of claim 1, wherein the supplemental content includes an animation.

7. The method of claim 1, wherein the supplemental content includes:
a rendering of a frame of the first channel as a first planar object that is folded into a point on the display; and
a rendering of a frame of the second channel as a second planar object that is unfolded from the point on the display.

8. The method of claim 1, wherein the supplemental content includes a fading out of the first channel and a fading in of the second channel.

9. The method of claim 1, wherein the supplemental content includes an advertisement.

10. A system for displaying content, comprising:
a receiver having a processor, the receiver operable to receive content on a plurality of channels;
a storage device connected to the processor, the storage device including one or more display inserts; and
a display mechanism connected to the receiver, the display mechanism operable to display content received by the receiver on the plurality of channels;
wherein during a channel change from a first channel to a second channel, the processor displays supplemental content on the display mechanism, the supplemental content being specified by the display insert.

11. The system of claim 10, wherein the display insert includes code executable by the processor.

12. The system of claim 10, wherein the display insert includes a digital image.

13. The system of claim 10, wherein the display insert includes an expiration date past which the display insert is no longer valid.

14. The system of claim 10, wherein the display insert is stored permanently in the storage device.

15. The system of claim 10, wherein the display insert is received over a communication link that is connected to the receiver.

16. A method of providing supplemental content, comprising:
receiving supplemental content;
attaching use-specifier information to the supplemental content; and
transmitting the supplemental content to a receiver;
wherein the use-specifier information indicates that the supplemental content is to be displayed during a channel change from a first channel to a second channel.

17. The method of claim 16, wherein the supplemental content is received from an advertising provider.

18. The method of claim 16, wherein the supplemental content includes a digital image.
